(19) United States
(12) Patent Application Publication
(10) Pub. No.: US 2020/0403254 A1
(43) Pub. Date: Dec. 24, 2020

(54) METHOD AND DEVICE FOR FORECASTING SERVICE LIFE AND REMAINING LIFE OF FUEL CELL

(71) Applicant: Tsinghua University, Beijing (CN)

(72) Inventors: Pucheng PEI, Beijing (CN); Xiaoning JIA, Beijing (CN); Dongfang CHEN, Beijing (CN); Ziyao WU, Beijing (CN); Peng REN, Beijing (CN); Shangwei HUANG, Beijing (CN)

(21) Appl. No.: 17/010,789

(22) Filed: Sep. 2, 2020

Related U.S. Application Data
(63) Continuation of application No. PCT/CN2018/094532, filed on Jul. 4, 2018.

(30) Foreign Application Priority Data
Jun. 27, 2018 (CN) 201810681086.7

(51) Int. Cl. H01M 8/04223; H01M 8/04537; H01M 8/1011

(52) U.S. Cl. CPC H01M 8/04223; H01M 8/1011; H01M 8/04582; H01M 8/04552

(57) ABSTRACT

Disclosed are a method and device for forecasting the service life and remaining life of a fuel cell. The method comprises: determining an end of life on the basis of the attenuation percentage of the current or power of a fuel cell at a constant voltage, completing the activation of the fuel cell, measuring a first polarization curve of the fuel cell; when the fuel cell runs for a preset time, measuring the second polarization curve of the fuel cell; acquiring the voltage attenuation rate or a current attenuation time constant of the fuel cell, and acquiring the service life and remaining life of the fuel cell via a forecasting formula.

### CROSS-REFERENCE TO RELATED APPLICATIONS

This application is a continuation of International Application No. PCT/CN2018/094532, filed Jul. 4, 2018, which claims priority to Chinese Patent Application No. 201810681086.7, filed Jun. 27, 2018, the entire disclosures of which are hereby incorporated by reference.

### TECHNICAL FIELD

The present disclosure relates to the field of fuel cell technologies, and more particularly to a method and device for forecasting a service life and remaining life of a fuel cell.

### BACKGROUND

With the depletion of world resources, proton exchange membrane fuel cells have received widespread attention due to their zero emission, no pollution, higher power density and energy utilization. However, the service life and cost of fuel cells are still key factors restricting their commercialization at this stage. Therefore, many scholars have been devoted to study the service life of fuel cells, including researches on durability of fuel cells, forecasting methods of fuel cells' service life, performance attenuating mechanism of fuel cells, and change rules of hydrogen permeability and catalyst activity during the aging process of fuel cells.

The related art includes the following methods: (1) life attenuation of the fuel cells at different temperatures is determined, meanwhile durability tests are carried out under different load conditions, which show that the service life of the fuel cell is related to the type of membrane and the experimental temperature; (2) the mechanism of voltage drop of the fuel cell under the cyclic operation conditions of cold start and thermal shutdown are searched, and it is found that relative humidity is a primary experimental parameter that affects the service life of the fuel cell; (3) a method for rapidly evaluating and forecasting the service life of the fuel cell is proposed through accelerated start-stop cycle experiments; (4) a method for rapidly forecasting the service life of the fuel cell is proposed based on experimental data of fuel cell vehicles; and (5) the change rule of hydrogen permeability is researched and a new method for fast measuring the hydrogen permeability is found.

However, in the related art, methods for forecasting the service life of fuel cells are generally based on voltage attenuation, but rarely based on current attenuation. Further, these methods in most cases may be more focused on the forecast of the service life of a certain type of fuel cell, especially the proton exchange membrane fuel cell, while there is a lack of a service life forecasting method applicable to various types of fuel cells.

### SUMMARY

Embodiments of the present disclosure seek to solve at least one of the problems existing in the related art to at least some extent.

Embodiments of a first aspect of the present disclosure provide a method for forecasting a service life and remaining life of a fuel cell. This method includes: determining an endpoint of life according to an attenuation percentage of a current or a power of the fuel cell at a constant voltage, completing activation of the fuel cell, and measuring a first polarization curve of the fuel cell; measuring a second polarization curve of the fuel cell after the fuel cell runs for a preset time; and acquiring a voltage attenuation rate or a current attenuation time constant of the fuel cell, and acquiring the service life and the remaining life of the fuel cell through a forecasting formula.

Embodiments of a second aspect of the present disclosure provide a device for forecasting a service life and remaining life of a fuel cell. The device includes: a first acquiring module, a second acquiring module, and a forecasting module. The first acquiring module is configured to: determine an endpoint of life according to an attenuation percentage of a current or a power of the fuel cell at a constant voltage, complete activation of the fuel cell, and measure a first polarization curve of the fuel cell. The second acquiring module is configured to measure a second polarization curve of the fuel cell after the fuel cell runs for a preset time. The forecasting module is configured to acquire a voltage attenuation rate or a current attenuation time constant of the fuel cell, and acquire the service life and remaining life of the fuel cell through a forecasting formula.

Embodiments of a third aspect of the present disclosure provide a device for forecasting a service life and remaining life of a fuel cell. The device includes a processor; and a memory for storing instructions executable by the processor; in which the processor is configured to:

determine an endpoint of life according to an attenuation percentage of a current or a power of the fuel cell at a constant voltage, completing activation of the fuel cell, and measuring a first polarization curve of the fuel cell;

measure a second polarization curve of the fuel cell after the fuel cell runs for a preset time; and

acquire a voltage attenuation rate or a current attenuation time constant of the fuel cell, and acquire the service life and remaining life of the fuel cell through a forecasting formula.

Embodiments of a fourth aspect of the present disclosure provide a non-transitory computer-readable storage medium having stored therein instructions that, when executed by a processor of a terminal, causes the terminal to perform the method for forecasting the service life and remaining life of a fuel cell as described in embodiments of the first aspect of the present disclosure.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The above and/or additional aspects and advantages of embodiments of the present disclosure will become apparent and more readily appreciated from the following descriptions made with reference to the drawings, in which:

FIG. 1 is a flowchart of a method for forecasting a service life and remaining life of a fuel cell according to an embodiment of the present disclosure;

FIG. 2 is a schematic diagram illustrating service life forecast of a method for forecasting a service life and remaining life of a fuel cell according to an embodiment of the present disclosure; and

FIG. 3 is a schematic diagram of a device for forecasting a service life and remaining life of a fuel cell according to an embodiment of the present disclosure.

### DETAILED DESCRIPTION

Embodiments of the present disclosure will be described in detail below, examples of which are shown in the accompanying drawings, in which the same or similar elements and elements having same or similar functions are denoted by like reference numerals throughout the descriptions. The embodiments described below with reference to the accompanying drawings are explanatory and illustrative, which are serve to explain the present disclosure, and shall not be construed to limit the present disclosure.

In a first aspect, embodiments of the present disclosure provide a method for forecasting a service life and remaining life of a fuel cell. This method includes: determining an endpoint of life according to an attenuation percentage of a current or a power of the fuel cell at a constant voltage, completing activation of the fuel cell, and measuring a first polarization curve of the fuel cell; measuring a second polarization curve of the fuel cell after the fuel cell runs for a preset time; and acquiring a voltage attenuation rate or a current attenuation time constant of the fuel cell, and acquiring the service life and remaining life of the fuel cell through a forecasting formula.

It should be illustrated that term “first polarization curve” used herein refer to a polarization curve obtained for the first time after the fuel cell is fully activated; and the term “second polarization curve” used herein refer to a polarization curve obtained after the fuel cell runs for a preset time.

The method for forecasting the service life and remaining life of the fuel cell according to embodiments of the present disclosure applies the current (power) attenuation rate characteristics at a constant voltage to the forecast of the service life of the fuel cell, so that the service life of the fuel cell can be rapidly forecasted with only need to measure the polarization curves of the fuel cell within two different time periods, thereby greatly reducing the cost for long-term test. At the same time, the method proposed according to embodiments of the present disclosure combines the voltage attenuation rate at a constant current with the current or power attenuation rate characteristic laws at the constant voltage to accurately forecast the service life of the fuel cell, which is applicable to forecast the service life of various types of fuel cells, thereby effectively reducing the forecast cost, and effectively improving the accuracy and applicability of forecast. Further, the method is efficient, simple and easy to implement.

Further, in an embodiment of the present disclosure, after acquiring the first polarization curve of the fuel cell, the method further includes: determining two different target points on the first polarization curve to correspond to different voltages and currents, respectively.

Further, in an embodiment of the present disclosure, after obtaining the second polarization curve of the fuel cell, the method further includes: determining two new target points on the second polarization curve according to the two different target points on the first polarization curve.

Further, in an embodiment of the present disclosure, the forecasting formula includes:

$${t}_{a} = \frac{{V}_{r} - {V}_{a}}{A}$$

$${t}_{s} = {t}_{L} - {t}_{a}$$

$${t}_{L} = {t}_{a} \cdot \frac{{XI}_{e}}{{I}_{e} - {I}_{b}}$$

$$or {t}_{L} = {t}_{a} \cdot \frac{ln ( 1 - X )}{ln ( {I}_{b} \text{/} {I}_{e} )}$$

$$or {t}_{L} = x τ , τ = \frac{{t}_{a}}{ln ( {I}_{e} \text{/} {I}_{b} )} ,$$

where Vᵣ is an average voltage of each fuel cell at one of the two different target points on the first polarization curve, in [V], Vₐ is an average voltage of each fuel cell corresponding to Iᵣ on the second polarization curve, in [V], A is a voltage attenuation rate at a constant current, in [V/h], Iₑ is a current density at the other one of the two different target points on the first polarization curve, in [A/cm²], I_{b} is a current density corresponding to a voltage Vₑ on the second polarization curve, in [A/cm²], X is a current attenuation percentage from the other one of the two different target points to the endpoint of life at a constant voltage, x is a time constant scale factor, τ is a current attenuation time constant at the voltage Vₑ, in [h], t_{L} is a forecasted service life of the fuel cell, in [h], tₐ is a used time of the fuel cell, in [h], and tₛ is a forecasted remaining life of the fuel cell, in [h].

Further, in an embodiment of the present disclosure, the fuel cell includes a proton exchange membrane fuel cell, a direct methanol fuel cell and a solid oxide fuel cell.

In a second aspect, embodiments of the present disclosure provide a device for forecasting a service life and remaining life of a fuel cell. The device includes: a first acquiring module, a second acquiring module, and a forecasting module. The first acquiring module is configured to determine an endpoint of life according to an attenuation percentage of a current or a power of the fuel cell at a constant voltage, complete activation of the fuel cell, and measure a first polarization curve of the fuel cell. The second acquiring module is configured to measure a second polarization curve of the fuel cell after the fuel cell runs for a preset time. The forecasting module is configured to acquire a voltage attenuation rate or a current attenuation time constant of the fuel cell, and acquire the service life and remaining life of the fuel cell through a forecasting formula.

The device for forecasting the service life and remaining life of the fuel cell according to embodiments of the present disclosure applies the current (power) attenuation rate characteristics at a constant voltage to the forecast of the service life of the fuel cell, so that the service life of the fuel cell can be rapidly forecasted with only need to measure the polarization curves of the fuel cell within two different time periods, thereby greatly reducing the cost of the fuel cell for long-term forecast. At the same time, the method proposed according to embodiments of the present disclosure combines the voltage attenuation rate at the constant current with the current or power attenuation rate characteristic laws at the constant voltage to accurately forecast the service life of the fuel cell, which is applicable to forecast the service life of various types of fuel cells, thereby effectively reducing the forecast cost, and effectively improving the accuracy and applicability of forecast. Further, the method is efficient, simple and easy to implement.

Further, in an embodiment of the present disclosure, the first acquiring module is further configured to determine two different target points on the first polarization curve to correspond to different voltages and currents, respectively.

Further, in an embodiment of the present disclosure, the forecasting module is further configured to determine two new target points on the second polarization curve according to the two different target points on the first polarization curve.

Further, in an embodiment of the present disclosure, the forecasting formula includes:

$${t}_{a} = \frac{{V}_{r} - {V}_{a}}{A}$$

$${t}_{s} = {t}_{L} - {t}_{a}$$

$${t}_{L} = {t}_{a} \cdot \frac{{XI}_{e}}{{I}_{e} - {I}_{b}}$$

$$or {t}_{L} = {t}_{a} \cdot \frac{ln ( 1 - X )}{ln ( {I}_{b} \text{/} {I}_{e} )}$$

$$or {t}_{L} = x τ , τ = \frac{{t}_{a}}{ln ( {I}_{e} \text{/} {I}_{b} )} ,$$

where Vᵣ is an average voltage of each fuel cell at one of the two different target points on the first polarization curve, in [V], Vₐ is an average voltage of each fuel cell corresponding to Iᵣ on the second polarization curve, in [V], A is a voltage attenuation rate at a constant current, in [V/h], Iₑ is a current density at the other one of the two different target points on the first polarization curve, in [A/cm²], I_{b} is a current density corresponding to a voltage Vₑ on the second polarization curve, in [A/cm²], X is a current attenuation percentage from the other one of the two different target points to the endpoint of life at a constant voltage, x is a time constant scale factor, τ is a current attenuation time constant at the voltage Vₑ, in [h], t_{L} is a forecasted service life of the fuel cell, in [h], tₐ is a used time of the fuel cell, in [h], and tₛ is a forecasted remaining life of the fuel cell, in [h].

Further, in an embodiment of the present disclosure, the fuel cell includes a proton exchange membrane fuel cell, a direct methanol fuel cell and a solid oxide fuel cell.

A method and device for forecasting a service life and remaining life of a fuel cell will be described in detail below with reference to the accompanying drawings, in which the method for forecasting the service life and remaining life of the fuel cell will be described first with reference to the accompanying drawings.

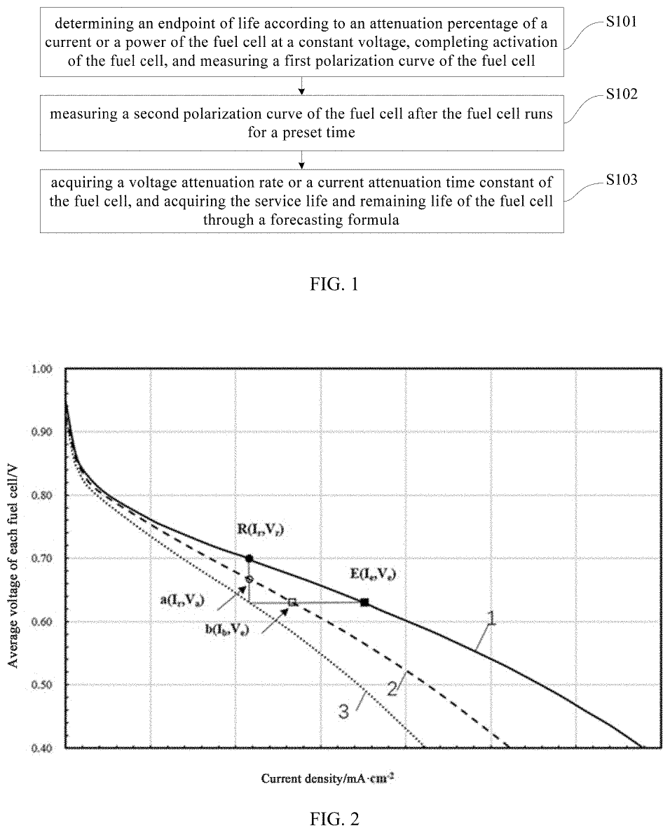

FIG. 1 is a flowchart of a method for forecasting a service life and remaining life of a fuel cell according to an embodiment of the present disclosure.

As illustrated in FIG. 1, the method for forecasting the service life and remaining life of the fuel cell includes the following steps.

At step S101, an endpoint of life is determined according to an attenuation percentage of a current or a power of the fuel cell at a constant voltage, activation of the fuel cell is completed, and a first polarization curve of the fuel cell is measured.

It is understood that, in embodiments of the present disclosure, a certain attenuation percentage of the current or the power of the fuel cell at the constant voltage is defined as the endpoint of life of the fuel cell; after the fuel cell is activated, the polarization curve of the fuel cell is tested. For example, as illustrated in FIG. 2, the first polarization curve (I-V curve 1) represents an initial performance of the fuel cell, i.e., corresponding to a performance of the fuel cell at time 0.

That is, with the aging of the fuel cell, embodiments of the present disclosure may define a certain attenuation percentage of the current or the power of the fuel cell at the constant voltage as the endpoint of life of the fuel cell, for later forecasting the service life and remaining life of the fuel cell.

It should be illustrated that, in embodiments of the present disclosure, the fuel cell is activated first, and if circumstances like membrane electrode damage or poisoning occur during the activation, it needs to replace the fuel cell with a new one and perform the above activation step again.

Alternatively, in an embodiment of the present disclosure, the fuel cell may include a proton exchange membrane fuel cell, a direct methanol fuel cell and a solid oxide fuel cell. The type of fuel cell may be selected by those skilled in the art according to actual situations, which is not specifically limited herein.

In an embodiment of the present disclosure, after the first polarization curve of the fuel cell is acquired, the method further includes determining two different target points on the first polarization curve to correspond to different voltages and currents, respectively.

It is understood that after the first polarization curve is measured, two different points need to be determined on the first polarization curve, which correspond to different voltages and currents, respectively, and corresponding data is recorded.

Specifically, first, a certain attenuation percentage of the current or the power of the fuel cell at the constant voltage is defined as the endpoint of life of the fuel cell, for example, when the attenuation percentage of the current or the power of the fuel cell at the constant voltage is X, which may be defined as the endpoint of life of the fuel cell. Then, the fuel cell is activated, and if circumstances like membrane electrode damage or poisoning occur during the activation, it needs to replace the fuel cell and perform the above activation step again. After activation, as illustrated in FIG. 2, the polarization curve of the fuel cell is tested as the first polarization curve 1. The first polarization curve 1 represents the initial performance of the fuel cell, i.e., corresponding to the performance of the fuel cell at time 0. At the same time, two different points R and E are determined on the first polarization curve, which correspond to different voltages Vᵣ, Vₑ and currents Iᵣ, Iₑ, respectively.

At step S102, a second polarization curve of the fuel cell is measured after the fuel cell runs for a preset time.

It is understood that, in embodiments of the present disclosure, a voltage attenuation rate may be calculated after the fuel cell runs for a period of time in actual use. That is, in embodiments of the present disclosure, a voltage attenuation rate A of the fuel cell in the actual use is calculated after the fuel cell runs for a period of time in actual use, so as to provide effective data support for later forecasting the service life and remaining life of the fuel cell. For example, after the fuel cell runs for not less than 200 hours in actual use, the voltage attenuation rate A at a constant current (Iᵣ) is calculated.

At step S103, a voltage attenuation rate or a current attenuation time constant of the fuel cell is acquired, and the service life and remaining life of the fuel cell are acquired through a forecasting formula.

It is understood that the second polarization curve is a second polarization curve of the fuel cell tested in embodiments of the present disclosure. In embodiments of the present disclosure, the second polarization curve is tested for the fuel cell, and the service life and remaining life of the fuel cell are forecasted using the formula proposed in embodiments of the present disclosure. In addition, in an embodiment of the present disclosure, after the second polarization curve of the fuel cell is acquired, the method further includes: determining two new target points on the second polarization curve according to the two different target points on the first polarization curve. It is understood that the second polarization curve is the second polarization curve of the fuel cell tested in embodiments of the present disclosure (such as an IV curve 2 shown in FIG. 2), and the second polarization curve of the fuel cell is used as a reference performance curve in an aging process of the fuel cell. Based on the two points previously determined on the I-V curve 1, two points are determined on the I-V curve 2 under a corresponding constant current and constant voltage, respectively, so as to provide data support for subsequent life forecast. It should be illustrated that an I-V curve 3 as shown in FIG. 2 corresponds to a polarization curve performance of the fuel cell when the fuel cell reaches the endpoint of life. Specifically, as illustrated in FIG. 2, the second polarization curve 2 of the fuel cell is tested and used as the reference performance curve in the aging process of the fuel cell, and based on the two points R and E determined on the first polarization curve 1, two points a and b are determined on the I-V curve 2 under the corresponding constant current and constant voltage, respectively, and the respective voltages of the two points a and b are Vₐ and Vₑ, respectively, and their respective currents are Iᵣ and I_{b}, respectively.

Further, in an embodiment of the present disclosure, the forecasting formula includes:

$$\begin{matrix}{t}_{a} = \frac{{V}_{r} - {V}_{a}}{A} & ( 1 ) \\ {t}_{s} = {t}_{L} - {t}_{a} & ( 2 ) \\ {t}_{L} = {t}_{a} \cdot \frac{{XI}_{e}}{{I}_{e} - {I}_{b}} & ( 3 ) \\ or {t}_{L} = {t}_{a} \cdot \frac{ln ( 1 - X )}{ln ( {I}_{b} \text{/} {I}_{e} )} & ( 4 ) \\ or {t}_{L} = x τ , τ = \frac{{t}_{a}}{ln ( {I}_{e} \text{/} {I}_{b} )} , & ( 5 )\end{matrix}$$

where Vᵣ is an average voltage of each fuel cell at the point R on the first polarization curve 1, in [V], Vₐ is an average voltage of each fuel cell corresponding to Iᵣ on the second polarization curve 2, in [V], A is a voltage attenuation rate at a constant current, in [V/h], Iₑ is a current density at the point E on the first polarization curve 1, in [A/cm²], I_{b} is a current density corresponding to a voltage Vₑ on the second polarization curve 2, in [A/cm²], X is a current attenuation percentage from the point E to the endpoint of life at a constant voltage, x is a time constant scale factor, τ is a current attenuation time constant at the voltage Vₑ, in [h], t_{L} is a forecasted service life of the fuel cell, in [h], tₐ is a used time of the fuel cell, in [h], and tₛ is a forecasted remaining life of the fuel cell, in [h].

Further, the above tested data is brought into the forecasting formula, so as to forecast the service life t_{L} and the remaining life tₛ of the fuel cell relatively accurately. Embodiments of the present disclosure provide two ways to forecast the service life and remaining life of the fuel cell: 1) if the used time tₐ of the fuel cell is unknown, the used time tₐ of the fuel cell may be calculated according to formula (1), so as to forecast the service life and remaining life of the fuel cell, respectively; 2) if the used time tₐ of the fuel cell is known, the service life and remaining life of the fuel cell may be forecasted respectively according to formulas (2)-(5).

The method for forecasting the service life and remaining life of the fuel cell according to embodiments of the present disclosure applies the current (power) attenuation rate characteristics at a constant voltage to the forecast of the service life of the fuel cell, so that the service life of the fuel cell can be rapidly forecasted with only need to measure the polarization curves of the fuel cell within two different time periods, thereby greatly reducing the cost of the fuel cell for long-term forecast. At the same time, the method proposed according to embodiments of the present disclosure combines the voltage attenuation rate at the constant current with the current or power attenuation rate characteristic laws at the constant voltage to accurately forecast the service life of the fuel cell, which is applicable to forecast the service life of various types of fuel cells, thereby effectively reducing the forecast cost, and effectively improving the accuracy and applicability of forecast. Further, the method is efficient, simple and easy to implement.

In the following, the device for forecasting the service life and remaining life of the fuel cell according to embodiments of the present disclosure is described with reference to the accompanying drawings.

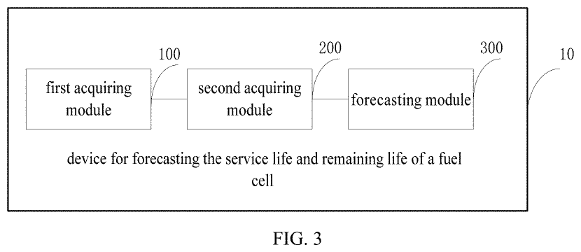

FIG. 3 is a schematic diagram of a device for forecasting a service life and remaining life of a fuel cell according to an embodiment of the present disclosure.

As illustrated in FIG. 3, the device 10 for forecasting the service life and remaining life of the fuel cell includes: a first acquiring module 100, a second acquiring module 200, and a forecasting module 300.

The first acquiring module 100 is configured to determine an endpoint of life according to an attenuation percentage of a current or a power of the fuel cell at a constant voltage, complete activation of the fuel cell, and measure a first polarization curve of the fuel cell; the second acquiring module 200 is configured to measure a second polarization curve of the fuel cell after the fuel cell runs for a preset time; and the forecasting module 300 is configured to acquire a voltage attenuation rate or a current attenuation time constant of the fuel cell, and acquire the service life and remaining life of the fuel cell through a forecasting formula. The device 10 according to embodiments of the present disclosure forecasts the service life and remaining life of the fuel cell by means of voltage attenuation and current attenuation characteristic laws, thereby effectively reducing forecasting costs, and effectively increasing the accuracy and applicability of the forecast. Further, the device is highly efficient, simple and easy to implement.

Alternatively, in an embodiment of the present disclosure, the first acquiring module 100 is further configured to determine two different target points on the first polarization curve to correspond to different voltages and currents, respectively.

In addition, in an embodiment of the present disclosure, the forecasting module 300 is further configured to determine two new target points on the second polarization curve according to the two different target points on the first polarization curve.

Further, in an embodiment of the present disclosure, the forecasting formula includes:

$${t}_{a} = \frac{{V}_{r} - {V}_{a}}{A}$$

$${t}_{s} = {t}_{L} - {t}_{a}$$

$${t}_{L} = {t}_{a} \cdot \frac{{XI}_{e}}{{I}_{e} - {I}_{b}}$$

$$or {t}_{L} = {t}_{a} \cdot \frac{ln ( 1 - X )}{ln ( {I}_{b} \text{/} {I}_{e} )}$$

$$or {t}_{L} = x τ , τ = \frac{{t}_{a}}{ln ( {I}_{e} \text{/} {I}_{b} )} ,$$

where Vᵣ is an average voltage of each fuel cell at the point R on the first polarization curve 1, in [V], Vₐ is an average voltage of each fuel cell corresponding to Iᵣ on the second polarization curve 2, in [V], A is a voltage attenuation rate at a constant current, in [V/h], Iₑ is a current density at the point E on the first polarization curve 1, in [A/cm²], I_{b} is a current density corresponding to a voltage Vₑ on the second polarization curve 2, in [A/cm²], X is a current attenuation percentage from the point E to the endpoint of life at a constant voltage, x is a time constant scale factor, τ is a current attenuation time constant at the voltage Vₑ, in [h], t_{L} is a forecasted service life of the fuel cell, in [h], tₐ is a used time of the fuel cell, in [h], and tₛ is a forecasted remaining life of the fuel cell, in [h].

Alternatively, in an embodiment of the present disclosure, the fuel cell includes a proton exchange membrane fuel cell, a direct methanol fuel cell and a solid oxide fuel cell.

It should be illustrated that the explanations and illustrations made hereinbefore for embodiments of the method for forecasting the service life and remaining life of the fuel cell are also applicable to the device for forecasting the service life and remaining life of the fuel cell of the embodiments of the present disclosure, which will not be elaborated herein.

The device for forecasting the service life and remaining life of the fuel cell according to embodiments of the present disclosure applies the current (power) attenuation rate characteristics at a constant voltage to the forecast of the service life of the fuel cell, so that the service life of the fuel cell can be rapidly forecasted with only need to measure the polarization curves of the fuel cell within two different time periods, thereby greatly reducing the cost of the fuel cell for long-term forecast. At the same time, the method proposed according to embodiments of the present disclosure combines the voltage attenuation rate at the constant current with the current or power attenuation rate characteristic laws at the constant voltage to accurately forecast the service life of the fuel cell, which is applicable to forecast the service life of various types of fuel cells, thereby effectively reducing the forecast cost, and effectively improving the accuracy and applicability of forecast. Further, the method is efficient, simple and easy to implement.

In a third aspect, embodiments of the present disclosure provide a device for forecasting a service life and remaining life of a fuel cell. The device includes a processor; and a memory for storing instructions executable by the processor; in which the processor is configured to:

determine an endpoint of life according to an attenuation percentage of a current or a power of the fuel cell at a constant voltage, completing activation of the fuel cell, and measuring a first polarization curve of the fuel cell;

measure a second polarization curve of the fuel cell after the fuel cell runs for a preset time; and

acquire a voltage attenuation rate or a current attenuation time constant of the fuel cell, and acquire the service life and remaining life of the fuel cell through a forecasting formula.

It should be illustrated that the explanations and illustrations made hereinbefore for embodiments of the method for forecasting the service life and remaining life of the fuel cell are also applicable to the device for forecasting the service life and remaining life of the fuel cell of the embodiments of the present disclosure, which will not be elaborated herein.

In a fourth aspect, embodiments of the present disclosure provide a non-transitory computer-readable storage medium having stored therein instructions that, when executed by a processor of a terminal, causes the terminal to perform the method for forecasting the service life and remaining life of a fuel cell as described in embodiments of the first aspect of the present disclosure.

In addition, terms such as “first” and “second” are used herein for purposes of description and are not intended to indicate or imply relative importance or significance or to imply the number of indicated technical features. Thus, the feature defined with “first” or “second” may explicitly or implicitly comprises one or more of this feature. In the description of the present invention, a phrase of “a plurality of” means two or more than two, such as two or three, unless specified otherwise.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, in the absence of contradiction, those skilled in the art can combine the different embodiments or examples described in this specification, or combine the features of different embodiments or examples.

Although embodiments of the present disclosure have been shown and described above, it would be appreciated by those skilled in the art that the above embodiments are explanatory, cannot be construed to limit the present disclosure, and changes, modifications, alternatives and variants can be made in the embodiments without departing from scope of the present disclosure.

What is claimed is:

1. A method for forecasting a service life and remaining life of a fuel cell, comprising:
determining an endpoint of life according to an attenuation percentage of a current or a power of the fuel cell at a constant voltage, completing activation of the fuel cell, and then measuring a first polarization curve of the fuel cell;
measuring a second polarization curve of the fuel cell after the fuel cell runs for a preset time; and
acquiring a voltage attenuation rate or a current attenuation time constant of the fuel cell, and acquiring the service life and remaining life of the fuel cell through a forecasting formula.

2. The method according to claim 1, after acquiring the first polarization curve of the fuel cell, further comprising:
determining two different target points on the first polarization curve to correspond to different voltages and currents, respectively.

3. The method according to claim 2, after obtaining the second polarization curve of the fuel cell, further comprises:
determining two new target points on the second polarization curve according to the two different target points on the first polarization curve.

4. The method according to claim 3, wherein the forecasting formula comprises:
$${t}_{a} = \frac{{V}_{r} - {V}_{a}}{A}$$
$${t}_{s} = {t}_{L} - {t}_{a}$$
$${t}_{L} = {t}_{a} \cdot \frac{{XI}_{e}}{{I}_{e} - {I}_{b}}$$
$$or {t}_{L} = {t}_{a} \cdot \frac{ln ( 1 - X )}{ln ( {I}_{b} \text{/} {I}_{e} )}$$
$$or {t}_{L} = x τ , τ = \frac{{t}_{a}}{ln ( {I}_{e} \text{/} {I}_{b} )} ,$$
where Vᵣ is an average voltage of each fuel cell at one of the two different target points on the first polarization curve, in [V], Vₐ is an average voltage of each fuel cell corresponding to Iᵣ on the second polarization curve, in [V], A is a voltage attenuation rate at a constant current, in [V/h], Iₑ is a current density at the other one of the two different target points on the first polarization curve, in [A/cm²], I_{b} is a current density corresponding to a voltage Vₑ on the second polarization curve, in [A/cm²], X is a current attenuation percentage from the other one of the two different target points to the endpoint of life at a constant voltage, x is a time constant scale factor, τ is a current attenuation time constant at the voltage Vₑ, in [h], t_{L} is a forecasted service life of the fuel cell, in [h], tₐ is a used time of the fuel cell, in [h], and tₛ is a forecasted remaining life of the fuel cell, in [h].

5. The method according to claim 1, wherein the fuel cell comprises a proton exchange membrane fuel cell, a direct methanol fuel cell and a solid oxide fuel cell.

6. A device for forecasting a service life and remaining life of a fuel cell, comprising:
a processor; and
a memory for storing instructions executable by the processor;
wherein the processor is configured to:
determine an endpoint of life according to an attenuation percentage of a current or a power of the fuel cell at a constant voltage, completing activation of the fuel cell, and measuring a first polarization curve of the fuel cell;
measure a second polarization curve of the fuel cell after the fuel cell runs for a preset time; and
acquire a voltage attenuation rate or a current attenuation time constant of the fuel cell, and acquire the service life and remaining life of the fuel cell through a forecasting formula.

7. The device according to claim 6, wherein the processor is further configured to: determine two different target points on the first polarization curve to correspond to different voltages and currents, respectively, after acquiring the first polarization curve of the fuel cell.

8. The device according to claim 7, wherein the processor is further configured to: determine two new target points on the second polarization curve according to the two different target points on the first polarization curve, after obtaining the second polarization curve of the fuel cell.

9. The device according to claim 8, wherein the forecasting formula comprises:
$${t}_{a} = \frac{{V}_{r} - {V}_{a}}{A}$$
$${t}_{s} = {t}_{L} - {t}_{a}$$
$${t}_{L} = {t}_{a} \cdot \frac{{XI}_{e}}{{I}_{e} - {I}_{b}}$$
$$or {t}_{L} = {t}_{a} \cdot \frac{ln ( 1 - X )}{ln ( {I}_{b} \text{/} {I}_{e} )}$$
$$or {t}_{L} = x τ , τ = \frac{{t}_{a}}{ln ( {I}_{e} \text{/} {I}_{b} )} ,$$
where Vᵣ is an average voltage of each fuel cell at one of the two different target points on the first polarization curve, in [V], Vₐ is an average voltage of each fuel cell corresponding to Iᵣ on the second polarization curve, in [V], A is a voltage attenuation rate at a constant current, in [V/h], Iₑ is a current density at the other one of the two different target points on the first polarization curve, in [A/cm²], I_{b} is a current density corresponding to a voltage Vₑ on the second polarization curve, in [A/cm²], X is a current attenuation percentage from the other one of the two different target points to the endpoint of life at a constant voltage, x is a time constant scale factor, τ is a current attenuation time constant at the voltage Vₑ, in [h], t_{L} is a forecasted service life of the fuel cell, in [h], tₐ is a used time of the fuel cell, in [h], and tₛ is a forecasted remaining life of the fuel cell, in [h].

10. The device according to claim 6, wherein the fuel cell comprises a proton exchange membrane fuel cell, a direct methanol fuel cell and a solid oxide fuel cell.

11. A non-transitory computer-readable storage medium having stored therein instructions that, when executed by a processor of a terminal, causes the terminal to perform a method for forecasting a service life and a remaining life of a fuel cell, the method comprising:
determining an endpoint of life according to an attenuation percentage of a current or a power of the fuel cell at a constant voltage, completing activation of the fuel cell, and then measuring a first polarization curve of the fuel cell;
measuring a second polarization curve of the fuel cell after the fuel cell runs for a preset time; and
acquiring a voltage attenuation rate or a current attenuation time constant of the fuel cell, and acquiring the service life and remaining life of the fuel cell through a forecasting formula.

12. The non-transitory computer-readable storage medium according to claim 11, wherein after acquiring the first polarization curve of the fuel cell, the method further comprises:
determining two different target points on the first polarization curve to correspond to different voltages and currents, respectively.

13. The non-transitory computer-readable storage medium according to claim 12, wherein after obtaining the second polarization curve of the fuel cell, the method further comprises:
determining two new target points on the second polarization curve according to the two different target points on the first polarization curve.

14. The non-transitory computer-readable storage medium according to claim 11, wherein the forecasting formula comprises:
$${t}_{a} = \frac{{V}_{r} - {V}_{a}}{A}$$
$${t}_{s} = {t}_{L} - {t}_{a}$$
$${t}_{L} = {t}_{a} \cdot \frac{{XI}_{e}}{{I}_{e} - {I}_{b}}$$
$$or {t}_{L} = {t}_{a} \cdot \frac{ln ( 1 - X )}{ln ( {I}_{b} \text{/} {I}_{e} )}$$
$$or {t}_{L} = x τ , τ = \frac{{t}_{a}}{ln ( {I}_{e} \text{/} {I}_{b} )} ,$$
where Vᵣ is an average voltage of each fuel cell at one of the two different target points on the first polarization curve, in [V], Vₐ is an average voltage of each fuel cell corresponding to Iᵣ on the second polarization curve, in [V], A is a voltage attenuation rate at a constant current, in [V/h], Iₑ is a current density at the other one of the two different target points on the first polarization curve, in [A/cm²], I_{b} is a current density corresponding to a voltage Vₑ on the second polarization curve, in [A/cm²], X is a current attenuation percentage from the other one of the two different target points to the endpoint of life at a constant voltage, x is a time constant scale factor, τ is a current attenuation time constant at the voltage Vₑ, in [h], t_{L} is a forecasted service life of the fuel cell, in [h], tₐ is a used time of the fuel cell, in [h], and tₛ is a forecasted remaining life of the fuel cell, in [h].

15. The non-transitory computer-readable storage medium according to claim 11, wherein the fuel cell comprises a proton exchange membrane fuel cell, a direct methanol fuel cell and a solid oxide fuel cell.
